(19) United States
(12) Patent Application Publication
(10) Pub. No.: US 2017/0324994 A1
(43) Pub. Date: Nov. 9, 2017

(54) HDMI MATRIX IP TRANSCEIVER

(71) Applicant: PAUL EDWARD HARRIS, MANALAPAN, NJ (US)

(72) Inventor: PAUL EDWARD HARRIS, MANALAPAN, NJ (US)

(21) Appl. No.: 15/658,522

(22) Filed: Jul. 25, 2017

Related U.S. Application Data
(63) Continuation of application No. 15/048,571, filed on Feb. 19, 2016, now abandoned.

(51) Int. Cl. H04N 21/4363; H04N 21/436; H04L 12/933

(52) U.S. Cl. CPC H04N 21/43635; H04L 49/109; H04N 21/43615

(57) ABSTRACT

Embodiments of the invention comprise an electronic device comprising a single unit configurable as a transmitter or a receiver IP extension unit through the use of an integrated AV matrix/switcher IC circuit and IP media processor. The AV matrix/switcher IC controls a flow of the HDMI signals to and from an IP media processor and allows one or more sources to be selected as an input to the IP media processor or received content from the IP media processor to be routed through an input of the AV matrix/switcher IC to one or more AV outputs of the AV matrix/switcher IC.

### CROSS-REFERENCE TO RELATED APPLICATIONS

This application is a continuation of and claims priority to U.S. patent application Ser. No. 15/048,571, filed Feb. 19, 2016, the contents of which is hereby incorporated by reference in its entirety.

### FIELD OF THE INVENTION

The present invention relates to audio-visual equipment.

### BACKGROUND OF THE DISCLOSURE

Conventional internet protocol (IP) media processors (or simply IP processors) are limited to encode or decode due to electrical pathways causing two individual products to be created, one for encode, the other for decode. The requirement for two individual products increases the cost and complexity of audio-visual solutions that use IP media processors.

### BRIEF SUMMARY OF THE DISCLOSURE

Embodiments of the invention allows both encode and decode to be selected within a single product by redirecting the electrical pathways relative to the mode of operation. Embodiments of the invention comprise an electronic device comprising a single unit configurable as a transmitter or a receiver IP extension unit through the use of an integrated AV matrix/switcher IC circuit and IP media processor. The AV matrix/switcher IC controls a flow of the HDMI signals to and from an IP media processor and allows one or more sources to be selected as an input to the IP media processor or received content from the IP media processor to be routed through an input of the AV matrix/switcher IC to one or more AV outputs of the AV matrix/switcher IC.

The AV Matrix/switcher IC may comprise an HDMI Matrix/switcher IC, a DisplayPort Matrix/switcher IC, a DVI Matrix/switcher IC, or an SDI Matrix/switcher IC.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a block diagram outlining the basic connection of the HDMI inputs and outputs to a single IP media processor with 2 HDMI connector inputs and 1 HDMI connector Output.

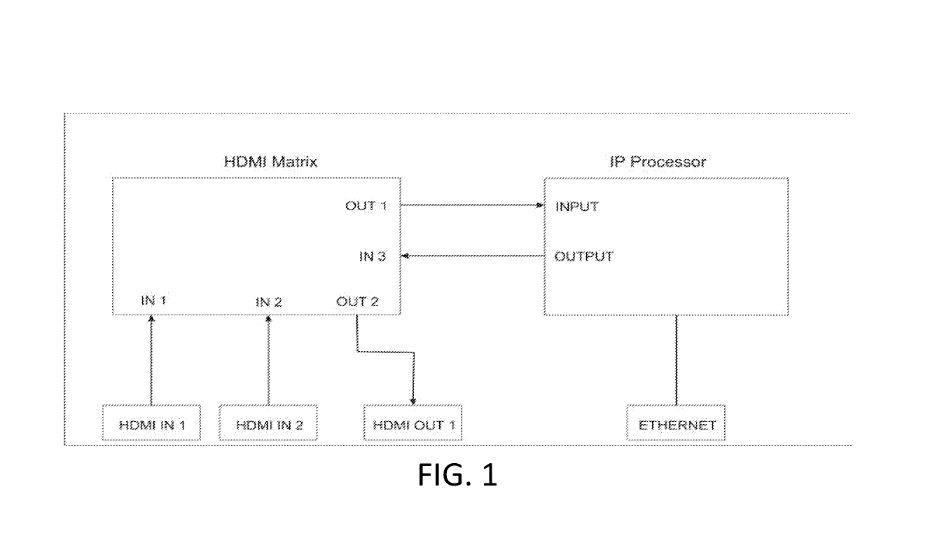

FIG. 2 is a block diagram outlining the basic connection of the HDMI inputs and outputs to two IP media processors with 2 HDMI connector inputs and 1 HDMI connector Output.

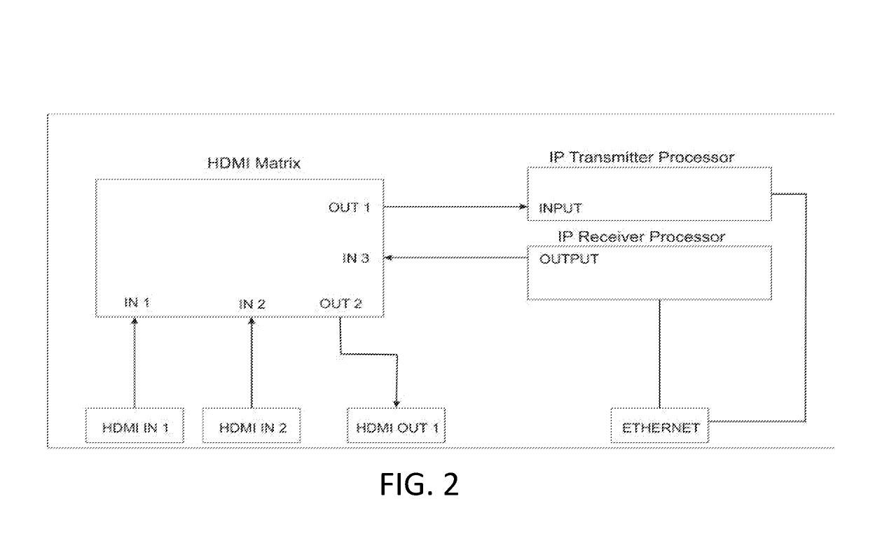

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

The invention relates to an HDMI electronic IP extension device comprising a single unit configurable as a transmitter or a receiver unit through the use of an integrated HDMI matrix circuit.

Embodiments of the invention comprise an electronic device comprised of an HDMI Matrix/Switcher IC and IP Extension Processor. The invention will carry out this process by utilizing an HDMI matrix/switcher IC to control the flow of the HDMI signals to and from the IP media processor. This allows one or more sources to be selected as the input to the IP media processor or received content from the IP media processor to be routed through the input of the HDMI matrix/switcher to an HDMI output of the HDMI matrix/switcher. This topology when configured as a transmitter can send the HDMI source over IP and can select which input is to be sent to the local HDMI output(s) of the unit. When configured as a receiver the IP content being received can be sent to the HDMI output(s) of the unit or same unit can select from one of the other HDMI input(s).

The main intent of the invention would be to eliminate the need for 2 different products to achieve the end to end results and it allows for local switching and loop-out capabilities of the HDMI sources.

TABLE 1
Definition List

| Term | Definition |
|---|---|
| HDMI | A compact audio/video interface for |
| | transmitting uncompressed digital data. |
| | HDMI connects digital audio/video |
| | sources (such as set-top boxes, DVD |
| | players, HD DVD players, Blu-ray Disc |
| | players, AVCHD camcorders, personal |
| | computers (PCs), video game consoles |
| | such as the PlayStation 3 and Xbox 360, |
| | and AV receivers) to compatible digital |
| | audio devices, computer monitors, video |
| | projectors, tablet computers, and digital |
| | televisions. |
| DVI | a video interface standard covering the |
| | transmission of video between a source |
| | device (such as a personal computer) |
| | and a display device. |
| Display Port | a digital display interface standard |
| | produced by the Video Electronics |
| | Standards Association (VESA). It defines |
| | a royalty-free, digital audio/video |
| | interconnect, intended to be used |
| | primarily between a computer and its |
| | display, or a computer and a home- |
| | theater system. |
| SDI | a standard for digital video transmission |
| | over coaxial cable. |
| Ethernet | a family of computer networking |
| | technologies for local area networks |
| | (LANs) commercially introduced in 1980. |
| | Standardized in IEEE 802.3, Ethernet has |
| | largely replaced competing wired LAN |
| | technologies. |
| Category Cable (CAT) | A twisted pair cable for carrying signals. |
| | This type of cable is used in structured |
| | cabling for computer networks such as |
| | Ethernet. It is also used to carry other |
| | signals such as telephony and video. The |
| | cable is commonly connected using |
| | punch down blocks and modular |
| | connectors. Most Category cables are |
| | unshielded, relying on the twisted pair |
| | design and differential signaling for |
| | noise rejection. There are different |
| | grades of cable available and code as 5, |
| | 5e, 6, or 7 accordingly. |
| Matrix | The ability to route a video or pc source |
| | to one or more destinations. |
| IP Extension | Method of delivering video content via |
| | Ethernet by fiber or CAT cable with or |
| | without compression. |

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. An electronic device comprising:
a single unit configurable as a transmitter or a receiver internet protocol (IP) extension unit through the use of an integrated audio-visual (AV) matrix/switcher integrated circuit (IC) and IP media processor;
wherein the AV matrix/switcher IC controls a flow of the HDMI signals to and from an IP media processor and allows one or more sources to be selected as an input to the IP media processor or received content from the IP media processor to be routed through an input of the AV matrix/switcher IC to one or more AV outputs of the AV matrix/switcher IC.

2. The electronic device of claim 1 wherein the AV Matrix/switcher IC comprises an HDMI Matrix/switcher IC.

3. The electronic device of claim 1 wherein the AV Matrix/switcher IC comprises a DisplayPort Matrix/switcher IC.

4. The electronic device of claim 1 wherein the AV Matrix/switcher IC comprises a DVI Matrix/switcher IC.

5. The electronic device of claim 1 wherein the AV Matrix/switcher IC comprises an SDI Matrix/switcher IC.
